(19) United States
(12) Patent Application Publication
(10) Pub. No.: US 2015/0019603 A1
(43) Pub. Date: Jan. 15, 2015

(54) Method for checking an output of a random number generator

(71) Applicant: Eberhard BOEHL, Reutlingen (DE)

(72) Inventor: Eberhard BOEHL, Reutlingen (DE)

(73) Assignee: Robert Bosch GmbH, Stuttgart (DE)

(21) Appl. No.: 14/325,527

(22) Filed: Jul. 8, 2014

(30) Foreign Application Priority Data
Jul. 9, 2013 (DE) 10 2013 213 382.0

(51) Int. Cl. G06F 7/58

(52) U.S. Cl. CPC G06F 7/588
USPC 708/203

(57) ABSTRACT

In a method for checking an output of a random number generator which includes at least one random source, the frequency of occurrence of at least one bit assignment is counted and established in a correlation with the total number of values which are taken into account.

### BACKGROUND OF THE INVENTION

1. Field of the Invention

The present invention relates to a method for checking an output of a random number generator and a system for carrying out the method.

2. Description of the Related Art

Random numbers as results or outputs of random number generators are necessary for numerous applications. Random number generators are processes which supply a sequence of random numbers. A crucial criterion of the quality of random numbers is whether the result of the generation may be regarded as independent of earlier results.

Random numbers are necessary for cryptographic processes, for example, which are used to generate keys for these encryption processes. Thus, random number generators (RNGs) are used to generate master keys for symmetrical encryption processes and protocol handshaking in elliptical curve cryptography (ECC), which prevent attacks of performance analysis and replay attacks.

There are two basic types of random number generators, the first being pseudo-random number generators (PRNGs) for high throughputs and low security levels. In a PRNG, a secret value is usually input, and each input value will always result in the same output sequences. However, a good PRNG will output a number sequence which appears to be random and which passes most tests.

It is important to note that stringent requirements regarding the random characteristics are imposed on keys for cryptographic processes. For this reason, pseudo-random number generators (PRNGs), represented by a linear feedback shift register (LFSR), for example, are not suitable for this purpose. Only a generator of true random numbers, referred to as a true random number generator (TRNG), meets the imposed requirements. The true random number generator represents the other type of random number generator. The true random number generator makes use of natural noise processes in order to obtain a nonpredictable result.

Noise generators which make use of the thermal noise from resistors or semiconductors, i.e., the shot noise at potential barriers, for example at pn transitions, are common. Another option is the utilization of the radioactive decay of isotopes.

Whereas the “classical” methods use analog elements such as resistors as noise sources, digital elements such as inverters are being used more frequently in recent times. These digital elements have the advantage of a less complicated circuit layout, since they are present as standard elements. In addition, such circuits may also be used in freely programmable circuits such as FPGAs.

Thus, for example, the use of ring oscillators which represent an electronic oscillator circuit is known. In ring oscillators, an odd number of inverters is interconnected to form a ring, resulting in oscillation at a natural frequency. The natural frequency is a function of the number of inverters in the ring, the properties of the inverters, and the conditions of the interconnection, namely, the line capacitances, the operating voltage, and the temperature. The noise of the inverters results in a random phase shift with respect to the ideal oscillator frequency, which is used as a random process for the TRNG. It is pointed out that ring oscillators oscillate independently and require no external components such as capacitors or coils.

The output of the ring oscillators may be compressed or subjected to post-processing in order to compress or bundle, i.e., increase, the entropy and eliminate any bias.

One problem in this regard is that the ring oscillator must preferably be sampled in the vicinity of an expected ideal edge in order to obtain a random sampled value. For this purpose, one option is described in the publication by Bock, H., Bucci, M., Luzzi, R.: “An Offset-compensated Oscillator-based Random Bit Source for Security Applications,” CHES 2005, in which the sampling always takes place in the vicinity of an oscillator edge due to the regulated shifting of the sampling point in time.

A method for generating random numbers with the aid of a ring oscillator is known from European Patent EP 1 686 458 B1, in which a first signal and a second signal are provided, the first signal being sampled as the result of triggering by the second signal. In the described method, a ring oscillator is sampled multiple times, only non-inverting delays, namely, an even number of inverters, being utilized as delay elements.

The oscillator ring is sampled simultaneously or with a mutual delay, beginning from a starting point, always after an even number of inverters. The shifting of the sampling point in time may thus be dispensed with; instead, the multiple sampling signals are evaluated.

A method is presented in the publication “Design of Testable Random Bit Generators” by Bucci, M. and Luzzi, R. (CHES 2005) via which an influence on the random source may be determined. Attacks may be prevented in this way. As a result, however, a direct distinction between random values and deterministic values is not possible. An assessment of the quality of the random source is possible by counting the transitions.

Another option is provided by the use of multiple ring oscillators. This is described, for example, in the publication Sunar, B. et al: “Approvable Secure True Random Number Generator with Built-in Tolerance Attacks,” IEEE Trans. on Computers, 1/2007. Sampling values of multiple ring oscillators are linked to one another and evaluated.

As previously stated, in ring oscillators an odd number of inverters is interconnected to form a ring, resulting in an oscillation at a natural frequency. The natural frequency is a function of the number of inverters in the ring, the properties of the inverters, and the conditions of the interconnection, i.e., the line capacitances, the operating voltage, and the temperature. The noise of the inverters results in a random phase shift with respect to the ideal oscillator frequency, which is used as a random process for the TRNG.

One advantageous implementation of a TRNG source with the aid of a ring oscillator which is sampled at multiple points is shown in FIG. 1. At the same time, this circuit offers the advantage that a correlation with the system clock pulse may be established and errors may be discovered when particular implementation conditions with a uniform capacitive load on all nodes of the ring oscillator are present, and the switching elements used, such as flip-flops or inverters, are designed in such a way that they preferably respond uniformly to rising and falling edges.

A method is presented in the publication “Design of Testable Random Bit Generators” by Bucci, M. and Luzzi, R. (CHES 2005) via which an influence on the random source may be determined. Attacks may be prevented in this way. As a result, however, a direct distinction between random values and deterministic values is not possible.

German patent document DE 60 2004 011 081 T2 describes an option for how a TRNG source may be tested according to so-called post-processing or post-treatment, and for this purpose, how this post-treatment may be shifted into a certification mode.

### BRIEF SUMMARY OF THE INVENTION

Methods known thus far, using solely digital elements as the entropy source, for example, an odd number of inverters connected to form a ring, sometimes require very complicated post-processing circuits, which on the one hand enhance the entropy and on the other hand ensure a uniform distribution of the random bits between the values 0 and 1.

The presented method represents a simple option for checking the quality of the internal random numbers after a single compression. A TRNG source having multiple outputs may be used, each of these outputs being equipped with a simple compression function, for example a serial XOR. The level of complexity of such a method is so low that a TRNG having approximately 200 gate equivalents may be implemented. This is much more favorable than with methods known thus far.

With the aid of the checking method according to the present invention presented here, the internal random numbers may be checked as to whether a distribution of the states of the compressed sampling bits is rather uniformly distributed, or whether there are dominant assignments of the three compressed sampling bits.

The assignment of the three bits is also referred to as bit assignment. For m bits, there are always 2^{m} different bit assignments.

Further advantages and embodiments of the present invention result from the description and the appended drawings.

It is understood that the features stated above and to be explained below may be used not only in the particular stated combination, but also in other combinations or alone without departing from the scope of the present invention.

### BRIEF DESCRIPTION OF THE DRAWINGS

FIG. 1 shows one design of a ring oscillator.

FIG. 2 shows the ring oscillator from FIG. 1 with a system for compression.

FIG. 3 shows the ring oscillator with another system for compression.

FIG. 4 shows one design of the described system.

FIG. 5 shows another design of the described system.

FIG. 6 shows another design of the described system.

FIG. 7 shows one design of a circuit system.

### DETAILED DESCRIPTION OF THE INVENTION

The present invention is schematically illustrated based on specific embodiments in the drawings, and is described in greater detail below with reference to the drawings.

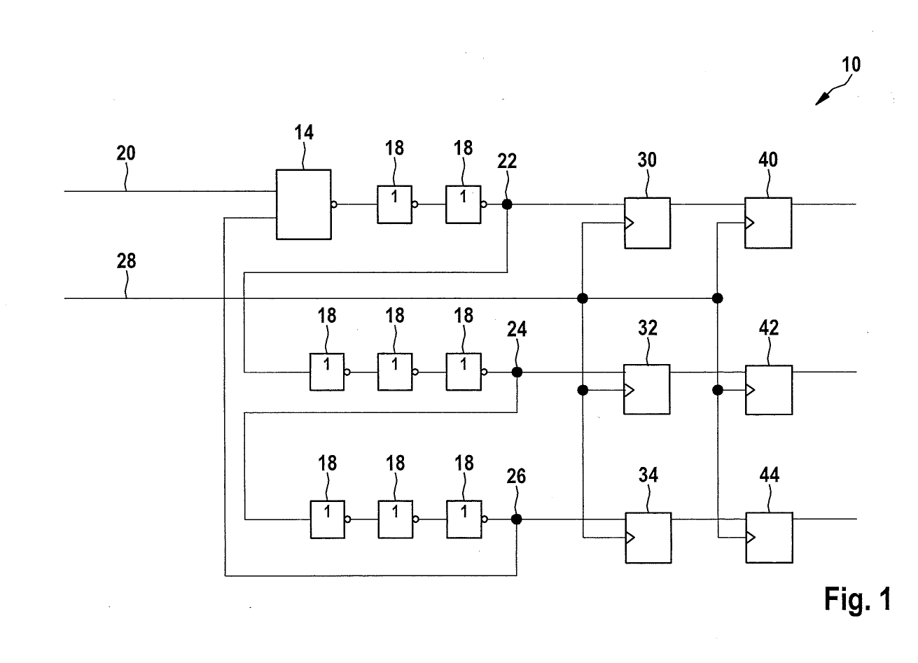

FIG. 1 shows one design of a ring oscillator which is denoted overall by reference numeral 10. Ring oscillator 10 has one NAND gate 14 and eight inverters 18, and thus has nine inverting elements. Ring oscillator 10 thus has an odd number of inverting elements and three taps or sampling points.

Ring oscillator 10 may be started and stopped via a first input 20. The sampling rate is predefined via a second input 28. In addition, the illustration shows a first sampling point 22, a second sampling point 24, and a third sampling point 26. This means that, beginning with first sampling point 22, sampling always takes place after an odd number of inverting elements. However, this is not absolutely necessary for the presented method.

First sampling point 22 is sampled via a first flip-flop 30, resulting in sampled value s10. Second sampling point 24 is sampled via a second flip-flop 32, resulting in sampled value s11. Third sampling point 26 is sampled via a third flip-flop 34, resulting in sampled value s12. An additional fourth flip-flop 40 is associated with first flip-flop 30. The fourth flip-flop fulfills a memory function and outputs value s10′, which chronologically succeeds value s10; i.e., s10 and s10′ are chronologically successive sampled values of first sampling point 22. Similarly, a fifth flip-flop 42 which outputs s11′ is associated with second flip-flop 32, and a sixth flip-flop 44 which outputs s12′ is associated with third flip-flop 34. Flip-flops 40, 42, and 44 are suitable for resolving metastable states of flip-flops 30, 32, and 34, respectively. Metastable states arise when the signal at input 28 is switched over to sampling point 22, 24, or 26 during an edge. Flip-flops 30, 32, and 34 then require a certain period of time until a stable end state is reached. In the present example, this period of time is ensured in that the value of flip-flops 30, 32, and 34, which is stable in the meantime, is not taken over in flip-flops 40, 42, and 44, respectively, until the following active edge of the signal at input 28.

In principle, ring oscillator 10 may thus be composed of, for example, nine inverters 18. One of these inverters 18 may be replaced by NAND element 14 in order to be able to stop ring oscillator 10. Alternatively, this NAND element 14 may be replaced by a NOR element.

In the embodiment shown, the values of ring oscillator 10 are simultaneously stored at three different inverters in each of first flip-flops (FF) 30, 32, 34. These taps should preferably be uniformly distributed over the elements of ring oscillator 10. Therefore, for the case of nine inversion stages in ring oscillator 10, a tap or a sampling point 22, 24, 26 is provided in each case after three inverting elements. However, as previously mentioned, this is not necessary for the presented method. It is also possible to once again provide a tap after an even number of inverting elements.

The number of inverter stages in ring oscillator 10 determines the frequency of the oscillator, and should therefore be selected in such a way that the flip-flops are able to store the particular signal value. When the highest possible oscillator frequency is used, the likelihood of being in the vicinity of an edge during the sampling is greater. For this reason, the lowest possible number of inverters in the oscillator ring is selected, but should be large enough that the flip-flops are operational for the achieved frequency. For 180-nm technology, a frequency of approximately 1 GHz has been determined by simulation for ring oscillator 10 having nine inverters 18. The flip-flops are able to store the signal values at this frequency, as has been demonstrated.

The presented method may be carried out using ring oscillator 10 according to FIG. 1, which has an odd number of inverting elements, values being tapped at least one sampling point of the ring oscillator. In one embodiment, sampling is carried out at multiple sampling points.

For ring oscillator 10, a correlation may be established with the system clock pulse, and thus with the sampling clock pulse obtained therefrom. For this purpose, a comparison is made as to whether the three bit values at the output of flip-flops 30, 32, and 34 are identical to those at the output of flip-flops 40, 42, and 44, respectively. Not all correlations can be established by comparing s10, s11, s12 to s10′, s11′, s12′, respectively, even if the divisor value of the frequency divider is divisible by the number of inverting elements in the oscillator ring. It may occur that in each case sampling is always carried out at the position in the oscillator cycle after an arbitrary, possibly constant, number of samplings. If this number is not at the same time a divisor of the number of inverting elements in the oscillator, no information about the existing correlation is obtained from the above-described comparison. It is still possible to establish the correlation if all samplings are compared to the instantaneous sampling. However, this is very complex.

For ring oscillator 10 according to FIG. 1, having nine inverters and three sampling points, for example, the bit values stored at the sampling points generally change [by] at least one bit value after a number of samplings which is not too large. A large number of successive identical bit values is recognized by counting warnings, and either signals an error, or the frequency of the oscillator is influenced.

Thus, as previously stated, nine inverters and three sampling points are provided for the ring oscillator according to FIG. 1. The states of the oscillator at the sampling point in time are stored in a first flip-flop, which in each case is connected to a sampling point of the oscillator. The second series of flip-flops which follows is suitable for compensating for metastable states in each first flip-flop. Such metastable states may arise due to the sampling clock pulse becoming active precisely during a state transition of the oscillator. Again storing the state in the respective second flip-flop ensures that the state of the first flip-flop may be adjusted over a period of the sampling clock pulse before this stable value is taken over in the second flip-flop. Desired performance may be achieved when this structure is implemented in a balanced manner. However, balancing requires use of special gates, namely, inverters and flip-flops, which have sufficiently similar driver strengths for the low-high edge and the high-low edge, also for the internal nodes of the flip-flops. In addition, the layout must be designed in such a way that the same load capacities are present for all taps of the ring oscillator and their controlling nodes. In a balanced circuit according to FIG. 1, bit assignments 000 and 111, for example, do not occur. The flip-flops are used as memory elements.

In a test chip in the present case, gates of a digital standard library have been used, and the ring oscillator additionally has a tap to which an amplifier is connected for the purpose of frequency measurement. In measurements on this test chip, it was possible to determine that the predicted distribution of the output bits does not apply. Values 000 as well as 111 occur. In addition, it was determined that the distribution of the remaining six states is not uniform, even when the sampling frequencies are varied. In particular, it was determined that in the observed test chip the number of samplings with the decimal values of the three sampling bits 3, 5, and 6 is much higher than those of sampling bits 1, 2, and 4.

When a post-treatment is carried out in which the three output bits are XOR-linked to one another, 0 occurs as the result much more often than does 1. Such skewing of the 0-1 distribution (bias) should in fact be avoided, or at least corrected by suitable post-processing. The obtained sequences of random bits are also referred to as internal random sequences, which should have a uniform distribution of 0 and 1 (see Killmann, W., Schindler, W.: AIS 31, Version 1, BSI, Sep. 25, 2001). If such a distribution of the internal random sequences is not possible, a complex structure which generates random numbers from the internal random sequences is also permitted as post-treatment or post-processing. Since such structures may possibly result in distortion which only conceals the actual, namely, inadequate, behavior, a special testing capability, even after the post-processing, is necessary if the test of the internal random sequences was not successful. This required certification mode is described in

German patent document DE 60 2004 011 081 T2, for example. If such a test is passed, the post-treatment structure is thus considered to be suitable, and the tests regarding the uniform distribution of 0 and 1 may also be demonstrated for the output data of this complex post-processing structure.

By use of the present method, it may be demonstrated that the singly compressed internal random numbers meet the requirements for uniform distribution.

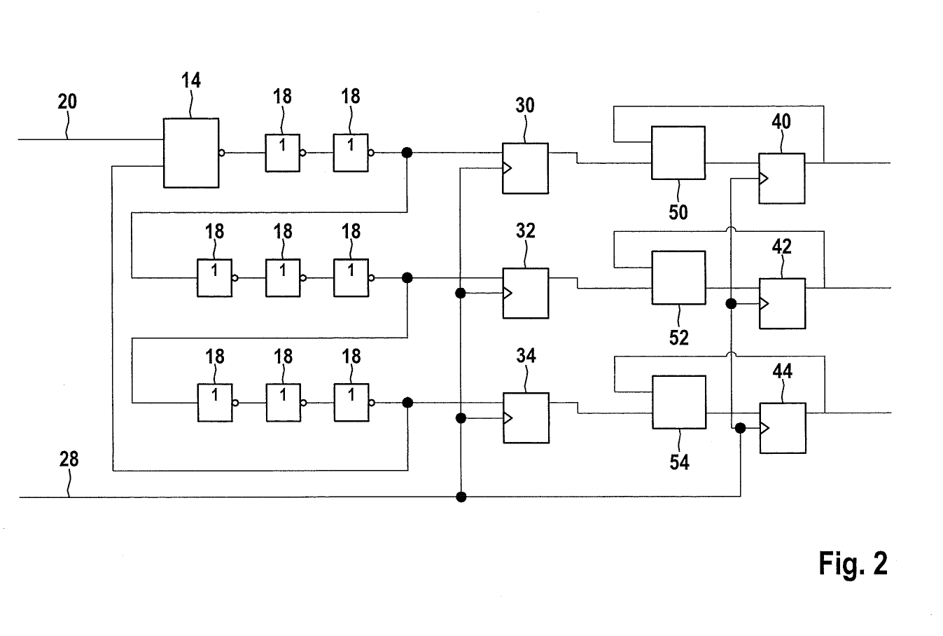

Single compression may already be carried out bit by bit before the individual bits are further processed. In the circuit in FIG. 2, for this purpose compression with a serial XOR in each case is provided before the value is stored in the particular subsequent flip-flop.

FIG. 2 shows ring oscillator 10 from FIG. 1, with a first XOR gate 50, a second XOR gate 52, and a third XOR gate 54 being additionally provided via which the bit-by-bit compression described above is carried out. The compressed values are input into second flip-flops 40, 42, and 44, the outputs of which are denoted by s10″, s11″, and s12″ (sli″), respectively.

After the sampled values of ring oscillator 10 have been stored in each of first flip-flops 30, 32, 34, each individual bit sli is XOR-linked to the output of a second flip-flop 40, 42, 44, respectively, in a second stage. Compression is achieved by allowing the value of sli to enter into the value of sli″ n times, for example.

At the same time, second flip-flop 40, 42, 44 fulfills the task of taking metastable states in first flip-flop 30, 32, 34, respectively, into account by providing an entire sampling period for adjusting this unstable state.

Compression rate n should be selected to be high enough that the prescribed 0-1 distribution is achieved for each individual bit. The further processing of the bits may take place via additional post-treatment structures which do without a certification mode. For this purpose, the three bits may be antivalently XOR-linked to one another, or may also enter in parallel into a post-processing structure. It is advantageous for compression factor n to preferably be odd. In this way, n successive zeros result in a different bit value (0) than n successive ones (1). Another possible advantage is that n is a prime number, since in that case the compression cannot be composed of a sum of multiple compressions.

The bit-by-bit serial XOR linkage on the one hand fulfills the purpose of eliminating nonuniform 0-1 distributions, and on the other hand the entropy (the random value) is enhanced due to the compression.

The improved distribution of 0 and 1 is determined by the magnitude of compression factor n. For a fairly large n, a better uniform distribution generally results. The test may be passed with an appropriately large n, as shown by experimental results.

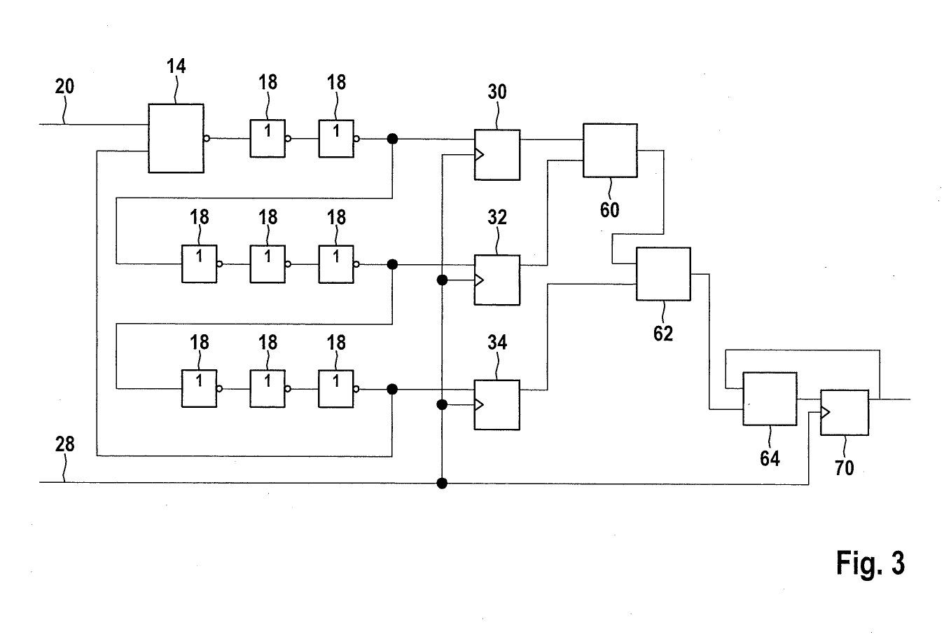

Supplementary reference is made to an alternative design according to FIG. 3.

FIG. 3 shows ring oscillator 10, having a first XOR gate 60 with output s01, a second XOR gate 62 with output s012, and a third XOR gate 64 with output s012′. An additional flip-flop 70 which outputs s012″ is also provided.

The advantage of this design is that it is necessary to serially compress only one signal with the aid of XOR. However, it should be noted that the properties of the circuit cannot be assessed as well as when the three compressed signals are present. Due to the linearity of the XOR operations, the output signals from FIG. 2 and FIG. 3 are the same when the three output signals s10″, s11″, and s12″ from FIG. 2 are linked via XOR to form a signal s012″:

s012″=s10″⊕s12″

where

s10″=s10(0)⊕s10(1)⊕s10(2) . . . ⊕s10(n−1)

s11″=s11(0)⊕s11(1)⊕s11(2) . . . ⊕s11(n−1)

s12″=s12(0)⊕s12(1)⊕s12(2) . . . ⊕s12(n−1)

resulting in the following from the above equation:

s012″=s10(0)⊕s10(1) . . . ⊕s10(n−1)⊕s11(0)⊕s11(1) . . . ⊕s11(n−1)⊕s12(0)⊕s12(1) . . . ⊕s12(n−1).

And according to FIG. 3:

s012=s10⊕s11⊕s12

and

s012″=s012(0)⊕s012(1)⊕s012(2) . . . s012(n−1)

resulting in the following from the above equation:

s012″=s10(0)⊕s11(0)⊕s12(0)⊕s10(1)⊕s11(1)⊕s12(1) . . . s10(n−1)⊕s11(n−1)⊕s12(n−1).

Due to the commutative law of antivalence, according to which the operands may be arbitrarily interchanged, both equations for s012″ are identical.

The presented method is described below in conjunction with

FIG. 2, but may also be carried out using a design according to FIG. 3.

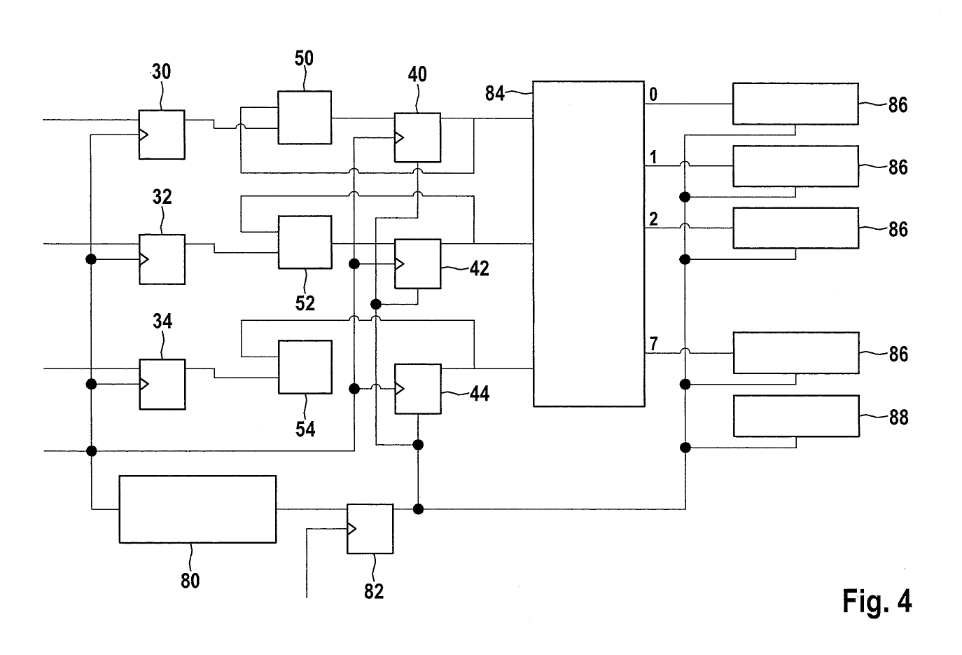

FIG. 4 shows the system from FIG. 2 together with a cycle divider 80, a delay element 82, a decoder 84, and counters 86 which count bit assignments individually, and a total counter 88.

The assignments of the three compressed bit values s10″, s11″ and s12″ according to FIG. 2 are now checked for their uniform distribution. All possible assignments of 000 over 001 through 111 should preferably occur with equal frequency. As shown in tests, such uniformly distributed values then successfully pass the customary, generally recognized statistical tests. For this purpose, for each bit distribution 000 through 111 (binary) or 0×0 through 0×7 (hexadecimal) or 0 through 7 (decimal), a counter 86 is provided which is incremented when the appropriate assignment occurs. For this purpose, an enable input of corresponding counter 86 is connected to the corresponding output of decoder 84. In addition, the total number of measured values is stored in a further counter, total counter 88, which is incremented with each measured value. The counting clock pulse is derived from the sampling clock pulse by using n-fold cycle divider 80 and also carrying out a delay using delay element 82, a flip-flop, which is controlled by the system clock pulse. The system clock pulse is typically a higher-frequency clock pulse from which the sampling clock pulse is obtained by frequency division. This additional delay is necessary to allow decoder 84 to adjust to the instantaneously reached value, and thus, to allow corresponding counter 86 to be enabled before the counting clock pulse becomes active.

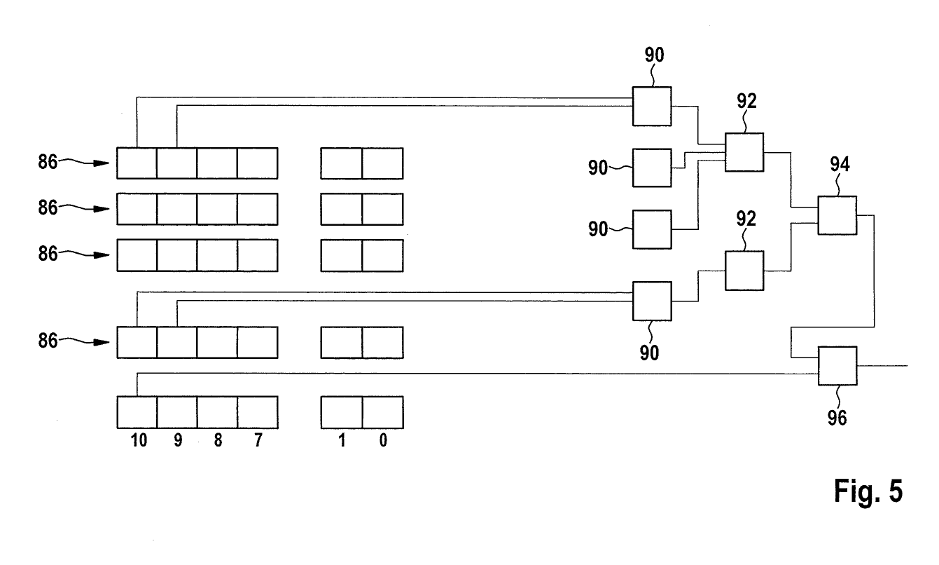

At the beginning, all counters 86 are set to 0. For each measured value (compressed bits s10″, s11″ and s12″), corresponding counter 86 is then incremented for the detected assignment (0 through 7), and total counter 88 is also incremented. For a previously set total counter value, which preferably is a value 2ⁱ, where i is a natural number, the counting operation is terminated and evaluated. If i=10, for example, 1024 values are evaluated. For a uniform distribution, all counters 86 of the individual values (for 0×0 through 0×7) would in each case indicate 1024/8=128 (decimal), 0×80 (hexadecimal), or 10000000 (binary). A statistical deviation must be permitted, depending on the number of total measurements. If a value occurs less frequently, at least one other value must occur more frequently. Evaluations of measuring results allow the conclusion to be drawn that when there is a deviation of a counter value of greater than approximately 100%, for example, no further values above this level are present which satisfy the statistical tests. Adherence to the 100% deviation may be tolerated only in the special case when the three output bits for forming the output bits of the random number generator are XOR-linked to one another, and thus mutually compensate for the large tolerances. Thus, in the special case it must be checked whether a counter 86 of the individual values is greater than 255. This is easily checked by masking the bit values 0 through 8 of counters 86, and checking whether only the upper bits, beginning with bit number 9, are different from 0. This is carried out by simple OR linkage of all applicable bit values 9 and 10 of all single counters. In this regard, reference is made to FIG. 5.

FIG. 5 shows counters 86 and total counter 88 together with first OR gates 90, second OR gates 92, a third OR gate 94, and an AND gate 96.

The procedure may be generally described as follows:
1. Set all counters to 0.
2. With each output of compressed bits sli″, increment the total counter, and after decoding the value of the three bits, increment the corresponding single counter until the total counter has reached the value 2ⁱ.
3. When the total counter has reached the value 2ⁱ (i is a natural number), check whether at least one of the single counters has reached a value of 2ⁱ⁻². In this case, an error signal is activated or an error bit is set.
4. When the error signal has been activated or the error bit has been set, it may be meaningful to increase the value of i, for example because not enough values have been used for the checking in order to have statistical reliability.
5. When the error signal has been activated or the error bit has been set, even though the value of i is regarded as large enough, compression factor n may also be increased in order to compress more sampled values sli to form a compressed value sli″ (see FIG. 2). In this regard, the frequency of the sampling clock pulse may thus also be increased.

6. Go to step 1.

In a generalization, the limit for the single counters may also be set to any other arbitrary values, and a check may be made as to whether the value has been exceeded by at least one single counter during the checking in step 3, i.e., a check for “greater than or equal to.” This check is carried out in the presented system by an evaluation unit or a comparator which may perform a comparison. The frequency of occurrence of at least one bit assignment of the compressed values in at least one counter or single counter is thus counted, and is established in a correlation with the total number of values which are taken into account.

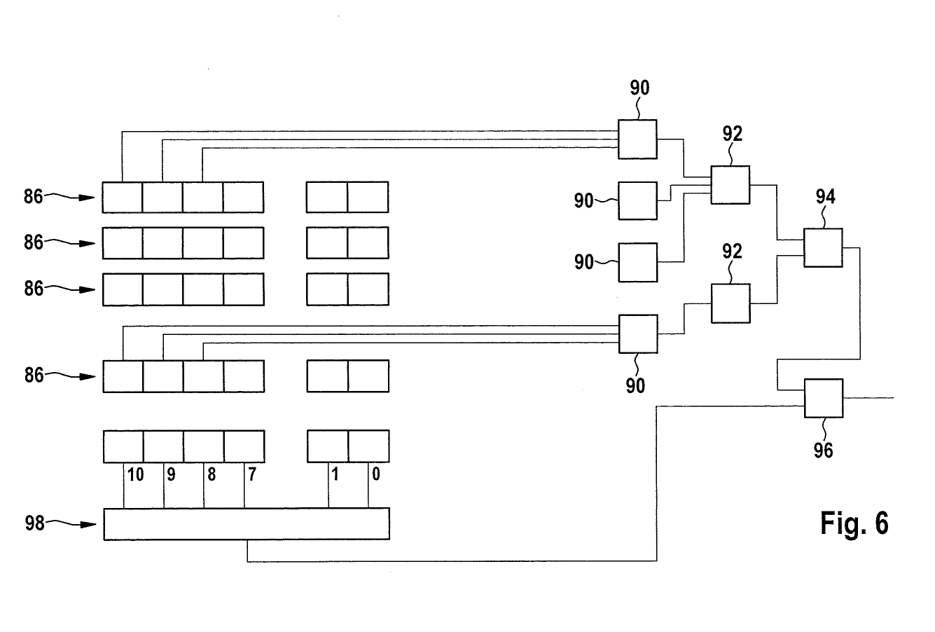

To this end, FIG. 6 shows a design based on that of FIG. 5, in which a comparator 98 is additionally provided which compares the counter content of total counter 88 to a predefined value, for example 2ⁱ−ε. The output signal of this comparator 98 is connected to AND element 96. Comparator 98 checks whether the end state of total counter 88 has been reached.

For this purpose, it may be advantageous to set the previously established total counter value to 2ⁱ−ε, where i is a natural number and ε is a tolerance value. For example, if i equals 10 and ε equals 32, 1024−32 =992 values are evaluated. For a uniform distribution, all counters 86 of the individual values for 0×0 through 0×7 would in each case then indicate 992/8=124 (decimal). In this case, it is advantageous, for example, to check whether a counter 86 exceeds the value 127.

A deviation of approximately 3% from the uniform distribution would then be demonstrated. For this purpose, it is necessary only to check the three upper bits of counter 86 as to whether at least one bit is equal to 1, as illustrated in FIG. 6.

The procedure may be generally described as follows:

1. Set all counters to 0.

2. With each output of compressed bits sli″, increment the total counter, and after decoding the value of the three bits, increment the corresponding single counter until the total counter has reached the value 2ⁱ−ε.

3. When the total counter has reached the value 2ⁱ−ε (i is a natural number), check whether at least one of the single counters has reached a value of 2ⁱ⁻³. In this case, an error signal is activated or an error bit is set.

4. When the error signal has been activated or the error bit has been set, it may be meaningful to increase the value of i, for example because not enough values have been used for the checking in order to have statistical reliability.

5. When the error signal has been activated or the error bit has been set, even though the value of i is regarded as large enough, compression factor n may also be increased in order to compress more sampled values sli to form a compressed value sli″ (see FIG. 2). In this regard, the frequency of the sampling clock pulse may thus also be increased.

6. Go to step 1.

It may now be advantageous to set value i to 17 and to set value ε to 3276 when checking the upper bits 15 through 17 of the counter for 1. This is similar to a known test in which 100000 values are to be checked as to whether they have a deviation of greater than 2.5% from the uniform distribution (see Killmann, W., Schindler, W.: AIS 31, Version 1, BSI, Sep. 25, 2001).

In another generalization, total counter 88 may be set to the value 2¹−ε at the start, and may be decremented with each new bit value sli″. As soon as total counter 88 reaches the value 0, checking of the other counters 86 is carried out as described above.

In a further simplification of the circuit from FIG. 6, counters 86 may in each case be limited to 8 bits (bits 0 through 7), and a carryover may be made to the highest bit position. Bits 8 through 10 may then be omitted when an individual additional memory element (flip-flop) is provided which is set precisely when at least one of the carryovers of counters 86 is active. The OR linkage of the individual bits of the counters may then be dispensed with, and the output of OR gate 94 is then replaced by the output of the additional memory element. This signal is then conjunctively linked to an end signal of total counter 88 in AND gate 96. This end signal is either the signal that total counter 88 is zero, namely, during decrementing of total counter 88, or a signal which indicates that the end value of the total counter has been reached.

In another generalization, more than three sampled values, for example m sampled values, of the oscillator may also be provided. In that case, 2^{m} single counters 86 in addition to a total counter 88 are necessary. The checking is also carried out, for example, when the counter content of the total counter is 2ⁱ and a check is made, for example, as to whether a single counter 86 has a value which is greater than 2^{1-m+1}. Here as well, the check is limited to the upper bits of single counters 86.

In another embodiment of the present invention, a check may also be made as to whether at least one single counter is below a predefined value, and in this case the error signal is activated.

After individual compressed sampling bits sli″ have been checked, they may be combined to form an individual bit s012″ and then stored.

s012″=s10″⊕s12″

where

s10″=s10(0)⊕s10(1)⊕s10(2) . . . ⊕s10(n−1)

s11″=s11(0)⊕s11(1)⊕s11(2) . . . ⊕s11(n−1)

s12″=s12(0)⊕s12(1)⊕s12(2) . . . ⊕s12(n−1)

resulting in the following from the above equation:

s012″=s10(0)⊕s10(1) . . . ⊕s10(n−1)⊕s11(0)⊕s11(1) . . . ⊕s11(n−1)⊕s12(0)⊕s12(1) . . . ⊕s12(n−1).

After compressed bit values s10″, s11″, and s12″ are provided, the flip-flops which have supplied these values are erased. For this purpose, the delayed counting clock pulse is used, as shown in FIG. 5.

A TRNG is implementable as intellectual property (IP) using the presented method. IP refers to a product which provides a circuit description, for example in a hardware description language, together with tests in such a way that customers of this product are able to implement the circuit on a chip using their own technology. Due to the extremely low circuit complexity, namely, approximately 200 gate equivalents, the product may be used practically anywhere that randomness plays a role. In the future, such TRNGs may be used in sensor evaluations for protection against manipulation, or in security applications for connections to the Internet. However, the complexity of circuitry for the counters for the checking according to the present invention must still be taken into account.

Moreover, a circuit, system having at least one ring oscillator is presented which includes a ring-shaped interconnection of an odd number of inverting elements, this ring oscillator being sampled at multiple positions, the sampled values being simultaneously stored in memory elements using a sampling clock pulse, and the outputs of the memory elements being connected to an input of a linear linkage element.

Furthermore, a circuit system having a random source is presented which has at least one digital output signal having a bit width of at least one bit, and a circuit for compressing this output signal, the circuit carrying out a block-by-block XOR linkage of n bits of each bit of the output signal to one bit in each case of a compressed output signal, and the sequence of compressed signal values thus formed being checked with regard to its distribution. Block-by-block compression means that n successive bits are linked to one another in series, for example via an XOR linkage or an XNOR linkage, where n refers to the compression factor.

The circuit system may be characterized in that compression factor n is influenced as a function of the result of the check of the distribution.

In addition, the random source may include at least one ring oscillator composed of a ring-shaped interconnection of an odd number of inverting elements, this ring oscillator being sampled with a clock pulse at at least one position.

The frequency of the sampling clock pulse may be influenced as a function of the result of the check of the distribution.

In addition, the frequency of the ring oscillator may be influenced as a function of the result of the check of the distribution, for example by the number of inverting elements in the ring oscillator, or by changing the operating conditions of the oscillator (operating voltage, temperature).

The output signal of the random source may be composed of multiple bits, and at least two of these bits may be combined via a linear linkage into one bit which is appropriately compressed by block-by-block XOR linkage of n bits, the compressed bit sequence being checked with regard to its distribution.

The output signal of the random source may be composed of at least k bits which are not linked to one another, each of these k bits being provided with a circuit for processing the output signal, the appropriately compressed k bits forming an assignment having 2^{k} possible values, the occurrences of all of these 2^{k} possible values being counted in separate counters, and the frequency of all of these assignments being compared to one another.

The distribution may also be checked, for example, by counting the occurrence of bit value 0 and bit value 1 in separate counters for m compressed output bits, and carrying out the comparison by difference formation of these counter values and comparison of the difference, as to whether they exceed a predefined limit.

The number of inverting elements in the ring oscillator may be changed as follows:

a) A generic approach in the synthesis, using a variable number of inverters (may be used only in an FPGA after new synthesis, fixed in the ASIC).

b) A structure of the ring oscillator having inverters is provided which may be partially bridged, controlled by a control signal. This additional circuit intensifies the nonuniform capacitances of the nodes in the ring oscillator.

However, this does not have an adverse effect when the compression factor and/or the sampling frequency is/are appropriately varied.

A change in the operating conditions of the oscillator may be provided, for example, by:

a) changing the operating voltage via a separately controllable supply voltage (explicitly led out) or by series resistors in the supply line of the ring oscillator (voltage drop)

b) changing the operating temperature, using heating or cooling elements which are selectively connected.

A mutual comparison means, for example, that the largest and the smallest number of an assignment are established by a greater than/smaller than comparison, for example:
a) by checking whether a difference becomes negative or
b) by sorting the assignment values (bit-by-bit decision, beginning with the MSB: at the first deviation at a bit position, the value having a 1 at this position is greater than the other)
   and then forming the difference between the largest and the smallest value, and in turn comparing this difference to a fixed limit.

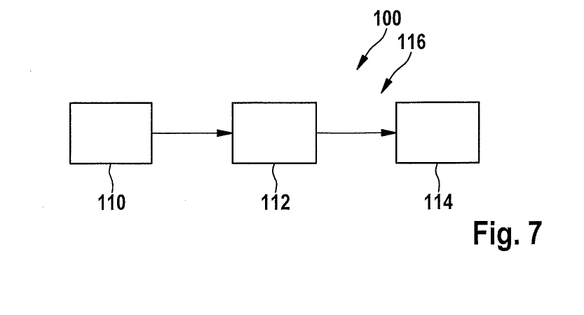

FIG. 7 shows a schematic illustration of a design of a circuit system which is denoted overall by reference numeral 100. This circuit system 100 includes a random source 110, a circuit 112 for compression, and a checking device 114. Circuit 112 and checking device 114 form a system 116 for carrying out the presented method. A so-called linear feedback shift register (LFSR), which is sufficiently known to those skilled in the art, or multiple chronologically successive output bits of the random source which are linearly linked to one another, may be used as circuit 112 for compression. It is possible that the output bits of the random source are repeatedly XOR-linked to various other signals.

What is claimed is:

1. A method for checking an output of a random number generator which includes at least one random source that delivers an output signal which is composed of at least one bit and which is processed by compression, the method comprising:
counting, in at least one counter, the frequency of occurrence of at least one bit assignment of the compressed values; and
establishing a correlation between the counted frequency and the total number of values which are taken into account.

2. The method as recited in claim 1, wherein the compression is a block-by-block compression of the individual bits.

3. The method as recited in claim 2, wherein:
the at least one random source includes at least one ring oscillator which is formed from a ring-shaped interconnection of an uneven number of inverting elements;
the ring oscillator is sampled at at least one sampling point; and
the sampled values are stored in memory elements, using a sampling clock pulse.

4. The method as recited in claim 2, wherein the sampled values are compressed bit by bit before the frequency of occurrence of at least one bit assignment of the output signal is determined.

5. The method as recited in claim 3, wherein an error signal is generated when a counter content of the at least one counter exceeds a specified threshold value.

6. The method as recited in claim 3, wherein an error signal is generated when a counter content of the at least one counter is below a specified threshold value.

7. The method as recited in claim 5, wherein the error signal is used to change the number of values which are taken into account.

8. The method as recited in claim 6, wherein the error signal is used to change the number of values which are taken into account.

9. The method as recited in claim 5, wherein the error signal is used to change a compression factor which is taken into account for the compression.

10. The method as recited in claim 6, wherein the error signal is used to change a compression factor which is taken into account for the compression.

11. The method as recited in claim 5, wherein the error signal is used to change the sampling frequency.

12. The method as recited in claim 6, wherein the error signal is used to change the sampling frequency.

13. The method as recited in claim 5, wherein the error signal is used to change the frequency of the ring oscillator.

14. The method as recited in claim 6, wherein the error signal is used to change the frequency of the ring oscillator.

15. A system for checking an output of a random number generator which includes at least one random source, the system comprising:
at least one counter configured to count the frequency of occurrence of at least one bit assignment of the sampled values; and
a comparator configured to establish a correlation between the counted frequency and the total number of values which are taken into account.

16. The system as recited in claim 15, wherein:
the at least one random source includes at least one ring oscillator which is formed from a ring-shaped interconnection of an uneven number of inverting elements;
the ring oscillator is sampled at at least one sampling point; and
the sampled values are stored in memory elements, using a sampling clock pulse.

17. The system as recited in claim 15, further comprising at least one circuit via which compression of sampled values is achieved with the aid of a linear linkage.
